(19) United States
(12) Patent Application Publication
(10) Pub. No.: US 2021/0141227 A1
(43) Pub. Date: May 13, 2021

(54) DISPLAY DEVICE, DISPLAY SYSTEM, METHOD OF CONTROLLING DISPLAY DEVICE, AND STORAGE MEDIUM

(71) Applicant: CANON KABUSHIKI KAISHA, Tokyo (JP)

(72) Inventor: Takeshi Iwasa, Kanagawa (JP)

(21) Appl. No.: 17/083,371

(22) Filed: Oct. 29, 2020

(30) Foreign Application Priority Data
Nov. 7, 2019 (JP) 2019-202620

(51) Int. Cl. G02B 27/01; G06F 3/01; G06F 1/3231

(52) U.S. Cl. CPC G02B 27/0172; G02B 2027/0178; G06F 1/3231; G06F 3/011

(57) ABSTRACT

A display device having a display element configured to display an image, the display device comprising: a wearing state determination unit configured to determine whether or not the display device is in a wearing state where the display device is worn by a user; a moving state determination unit configured to determine whether the display device is in a stopping state where the display device is stopping or in a moving state where the display device is moving; and a control unit configured to control the display element to be in a lighting enabled state when the display device is in the wearing state and in the moving state.

### BACKGROUND OF THE INVENTION

### Field of the Invention

The present invention relates to a display device, a display system, a method of controlling a display device, and a storage medium.

### Description of the Related Art

Virtual reality (VR) technology has been known as technology that allows an experience of a virtual space, and mixed reality, so-called MR technology, has been known as technology that seamlessly fuses a real space and a virtual space in real time. In an MR system that utilizes a video see-through type head mounted display (HMD), an HMD wearer observes composite images where computer graphics (CG) images are superimposed on real space images captured by an image capturing unit incorporated in the HMD. These images are independent corresponding to the left and right eyes, and a three-dimensional MR space by stereoscopic moving images can be presented to the HMD wearer. In VR, virtual space images are used instead of real space images.

In devices that handle moving images with high definition and high precision and that are represented by VR and MR systems, organic light-emitting diodes (OLEDs) are often used as display devices. OLEDs are developing devices, and there are problems such as degradation over time and burn-in. To reduce or prevent these problems, it is desirable to turn off the OLED as much as possible except during use. Moreover, there are cases where a message for reminding the wearer of long time use is displayed on the display because when the HMD is mounted, the HMD may cause the wearer to feel sick.

Japanese Patent Laid-Open No. 2008-257671 discloses a method of indicating restart and extension of an MR experience by a use state detection unit in addition to turning off a panel or a power supply after a certain period of time elapses.

However, in the technology described in Japanese Patent Laid-Open No. 2008-257671, even when an experience is interrupted, the light of a display may not be turned off for a certain period of time thereafter.

The present invention has been made in view of the above problems, and provides technology that suppresses unnecessary lighting of a display.

### SUMMARY OF THE INVENTION

According to one aspect of the present invention, there is provided a display device having a display element configured to display an image, the display device comprising: a wearing state determination unit configured to determine whether or not the display device is in a wearing state where the display device is worn by a user; a moving state determination unit configured to determine whether the display device is in a stopping state where the display device is stopping or in a moving state where the display device is moving; and a control unit configured to control the display element to be in a lighting enabled state when the display device is in the wearing state and in the moving state.

Further features of the present invention will become apparent from the following description of exemplary embodiments (with reference to the attached drawings).

### BRIEF DESCRIPTION OF THE DRAWINGS

FIG. 1A and FIG. 1B are a block diagram and a schematic diagram illustrating a schematic configuration of an image capturing and displaying system according to a first embodiment.

FIG. 2 is an outlined schematic diagram illustrating a configuration of an image processing control circuit according to the first embodiment.

FIG. 3A and FIG. 3B are outlined schematic diagrams illustrating state shift of the image capturing and displaying device according to the first embodiment.

FIG. 4 is a timing chart illustrating a control operation of the image capturing and displaying system according to the first embodiment.

FIG. 5 is a timing chart illustrating another example of a control operation of the image capturing and displaying system according to the first embodiment.

FIG. 6 is an outlined schematic diagram illustrating a control configuration of an image capturing and displaying system according to a second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

### System Configuration

FIG. 1A and FIG. 1B are diagrams illustrating an image capturing and displaying system including an image capturing and displaying device according to the present embodiment, FIG. 1A is a system block diagram, and FIG. 1B is a schematic diagram illustrating an appearance of the system and an example of a mounted state of the system. As illustrated in FIG. 1A and FIG. 1B, an image capturing and displaying system 1 includes a head-mounted type image capturing and displaying device (hereinafter, referred to as an HMD) 10, an image compositing apparatus (PC workstation (PCWS)) 30, and a cable 20 connecting both of them. The image compositing apparatus 30 generates an image (hereinafter, a composite image) of a mixed reality (MR) space in which a real space and a virtual space are fused, and provides the generated image to the HMD 10. Note that the cable 20 is illustrated as a communication path of wired connection, but a communication path of wireless connection may be used.

First, a configuration of the HMD 10 will be described. In FIG. 1A, image capturing elements 150a and 150b are complementary metal oxide semiconductor (CMOS) image sensors, charge coupled device (CCD) image sensors, or the like. The image capturing elements 150a and 150b acquires a captured image of a real space via an optical system (not illustrated) according to an exposure time period, a sensor gain, exposure start timing, and the like set based on a control signal from a control circuit.

Display elements 110a and 110b are organic light-emitting diodes (OLEDs), liquid crystal displays (LCDs), or the like, and present a composite image to a wearer of the HMD 10 via an optical system (not illustrated). In the present embodiment, since a three-dimensional image using an image for the right eye and an image for the left eye is handled, the image capturing elements 150a and 150b, and the display elements 110a and 110b are configured to be paired as elements for the right eye and for the left eye.

Further, from captured images of the image capturing elements 150a and 150b, an image for background that is a base of a composite image, and an image for position detection for generating a CG image are generated. Since the image for background and the image for position detection require different angles of view, resolutions, image processing, and the like, in the present embodiment, a method of cutting out the other from a captured image of the same image capturing device is assumed, but separate image capturing devices may be used.

An inertial measurement unit (IMU) 120 is a so-called position and orientation sensor that can detect an angular velocity and acceleration of three axes to calculate a position and an orientation of the device, and detects position and orientation information of the HMD 10. A switch (SW) 130 is an input unit that can be pressed by the wearer. A proximity sensor 140 detects whether or not the HMD 10 is worn on the head of the wearer in a state where MR can be experienced. An image processing control circuit (hereinafter, a control unit) 100 performs image processing necessary for a captured image and a display image, controls each of devices, and operates in coordination with the image compositing apparatus 30. Technology related to image-capturing and displaying of a three-dimensional image has been known, and thus description thereof is omitted.

The image compositing apparatus 30 includes a position detection unit 300, a CG generation unit 310, and a composition unit 320. The position detection unit 300 outputs information required to generate a CG image such as a position and an angle of line of sight for generating the CG image, based on an image for position detection and position and orientation information of the HMD 10 that are transmitted from the HMD 10. The CG generation unit 310 generates a prescribed CG image in accordance with the output of the position detection unit 300. The CG image is rendered based on CAD data (not illustrated) stored in a hard disc drive (HDD) or the like (not illustrated) in the image compositing apparatus 30. The composition unit 320 generates a composite image by superimposing the CG image on an image for background transmitted from the HMD 10, and outputs the generated image to the HMD 10 as an image for display.

Configuration of Image Processing Control Circuit

FIG. 2 is a schematic diagram illustrating a detailed configuration of the image processing control circuit 100 and a relationship between the image processing control circuit 100 and various external devices, and an outline of flows of images and control signals inside or around the image processing control circuit 100.

The image processing control circuit 100 includes not only an image processing circuit 600 and a display control circuit 500 but also various control circuits (not illustrated)(circuits that perform device control and communication control, such as management of an operation mode to be described below or the like, with the image compositing apparatus 30).

The image processing circuit 600 includes a message superimposition unit 610 that superimposes a message (on-screen display (OSD)) on image data of a composite image, in addition to various image processing circuits (not illustrated) that perform gamma adjustment, distortion aberration correction, captured-image processing, and the like. The image data input to the image processing circuit 600 and passed through the message superimposition unit 610 is output to the display elements 110a and 110b.

The display control circuit 500 includes a display panel control unit 510 and a display content control unit 520. The display content control unit 520 outputs a message control signal 570 to the message superimposition unit 610 based on instruction information (for example, SW pressing information) 560 from the display panel control unit 510 and time-out information from a timer (not illustrated). The message control signal 570 is a control signal for specifying a message type and a superimposition necessity that are superimposed on a composite image.

The display panel control unit 510 outputs a panel lighting control signal 550 to the display elements 110a and 110b, based on position and orientation information of the HMD 10 input from the IMU 120, wearing information (or non-wearing information) input from the proximity sensor 140, switch pressing information input from a SW 130 and the time-out information input from the timer (not illustrated). The panel lighting control signal 550 can control turning-on/off of the light of the display elements 110a and 110b. In addition, when the display panel control unit 510 acquires the pressing information from the SW 130, the display panel control unit 510 sets the timer (not illustrated) according to an operation mode of the image capturing and displaying system 1 to be described later.

Note that the configuration illustrated in FIG. 2 is not limited to this configuration. For example, the IMU 120 and the SW 130, the proximity sensor 140, and the like may be connected to the display panel control unit 510 and the display content control unit 520 via various control circuits (not illustrated).

State of HMD

Here, a state of the HMD 10 related to display control will be described using FIG. 3A and FIG. 3B. FIG. 3A is a diagram illustrating the state of the HMD 10 detected by the IMU 120 and the proximity sensor 140. The IMU 120 can detect whether the HMD 10 is moving (during moving (in a moving state), a in the figure), or stopping (during stopping (in a stopping state)) (moving state determination processing). Furthermore, the proximity sensor 140 can detect whether the HMD 10 is mounted on the head of the wearer in a state where MR can be experienced (during wearing (in a wearing state), β in the figure) or not (that is, in a non-wearing state) (wearing state determination processing). Therefore, there are four states denoted by I to IV in the figure because the HMD 10 shifts between states of wearing and non-wearing due to events of wearing detection or release detection, and also shifts between states of stopping and moving due to events of moving detection or stopping detection. This is converted to a Venn diagram as illustrated in FIG. 3B. Note that, concerning occurrence conditions of the moving detection and the stopping detection, it is assumed that the human head is naturally moving as long as the human consciously stops his or her body, and a threshold value, a chattering prevention time period, and the like may be optimized experimentally.

Use Case

Next, a use case according to the present embodiment will be described using FIG. 4. Time passes from the top to the bottom in the figure, and a status changes from moment to moment from a period A to a period P. The “wearing state” is determined as wearing or non-wearing, based on the output of the proximity sensor 140. The “moving state” is determined as during moving or during stopping, based on the output of the IMU 120. The “display property” is determined by a logical product of the “wearing state” and the “moving state”, and becomes a displayable state (that is, a lighting enabled state in which the lights of the display elements 110a and 110b are allowed to be turned on) only during wearing and during moving.

The “panel state” represents lighting/non-lighting of the display elements 110a and 110b, and when the lights of the display elements 110a and 110b are turned on, at least the “display property” is required to be displayable. The “display content” represents output image data to the display elements 110a and 110b (hereinafter, referred to as panels). For example, a composite image on which any one of two types of messages “precautions for use” and “warning for long time” is superimposed, or a composite image on which no message is superimposed is selected. The “SW input” indicates that the SW 130 is pressed. When the “timer” is set by the display panel control unit 510, countdown is started or paused, and time-out is notified when the countdown is completed. The portions illustrated by thin diagonal lines in the figure indicate that countdown is paused. A predetermined period of time of the timer may be set to an appropriate time for a single MR experience, for example, 30 minutes or the like.

Hereinafter, description will be sequentially given from the first period A. The period A is a state in which the image capturing and displaying system 1 is activated and the HMD 10 is placed on a desk or the like in a state (operation mode) ready for the MR experience. The wearer picks up the HMD 10 by the hand (the period B), and correctly wears the HMD 10 on the head to complete the wearing (the period C). When the wearer presses the SW 130 to cause the screen to be displayed, countdown of the timer (30 minutes) begins (the period D).

When the SW 130 is pressed once again, the timer is canceled, and the “precautions for use” message is displayed in which cautions before starting of the MR experience are described (the period E). Note that operations related to the period C or the period D may be designed to be omitted as appropriate. When the SW 130 is pressed again in order to start the MR experience, the message disappears and countdown of the timer begins (the period F).

The period G is a state in which the wearer utilizes, for example, a flip-up mechanism (not illustrated) by which the wearer flips up the HMD 10 while wearing a wearing tool on the head in order to pause the MR experience. At this time, as long as at least the timer is not canceled, the timer may be paused or may not be paused. In a case where the timer is paused as indicated by the diagonal lines in the figure, when the wearer lowers the flip-up mechanism to restart the MR experience (the period H), the countdown is restarted.

In a case where the timer is not paused as indicated by the dotted lines, when time-out occurs during the period, the panel state is in the non-lighting state, but the “warning for long time” message is output as the image data (display content). In this case, the light of the panel is turned on in a state where the “warning for long time” message is displayed at the time when the wearer lowers the flip-up mechanism.

On the other hand, in a case where the timer is paused, the “warning for long time” message is displayed (the period I) when time-out occurs after the MR experience is restarted (the period H). The output of the message is also continued as the image data while the HMD 10 is flipped up and the operation is stopped in the same manner as described above during the output of the message (the period J). When the SW 130 is pressed after the flip-up mechanism is lowered and the light of the panel is turned on (the period K), the “warning for long time” message disappears and the MR experience can be continued (the period L). At this time, the countdown of the timer is naturally started.

When the wearer finishes the operation and removes the HMD 10 from the head (the period M), similarly to the period G, the timer may be paused. While the removed HMD 10 is placed on a head type cradle, or the like (the period N), it indicates the wearing state and the stopping state. When the HMD 10 is removed from the cradle (the period O) and is placed on a desk to be in the non-wearing state and in the stopping state (the period P), the timer is canceled and the HMD 10 returns to the same state as the period A.

The use case in the state in which the image capturing and displaying system 1 is activated and MR is ready to be experienced (the operation mode in which a composite image can be displayed) has been described.

Next, a use case in an operation mode before the image capturing and displaying system 1 is activated will be described with reference to FIG. 5. The operation mode before the system is activated is such a state that software required on a PC (image compositing apparatus 30) side is not activated and the panel is displayed with a desktop screen of the PC rather than the composite image. In this case, this is not a state where MR can be experienced, so that even when the light of the panel is turned on, it is desired to turn off the light of the panel in a short time, for example, one minute.

A use case from a period A′ to a period C′ in the figure is similar to the use case in FIG. 4. When the SW 130 is pressed in a displayable state and in a non-lighting state of the panel (the period C′), countdown (one minute) of the timer starts (a period D′). When the countdown is completed and time-out occurs, the panel state returns to the non-lighting state of the panel (a period E′).

Then, when the SW 130 is pressed again in the lighting state of the panel (a period F′), the timer is reset and countdown (one minute) starts again (a period G′). When the HMD 10 is removed from the head in this state, the timer is canceled, and the light of the panel is turned off (a period H′), and when the HMD 10 is placed on a desk, the state returns to a state similar to that of the period A′ (a period I′).

As described above with reference to FIG. 4 and FIG. 5, the HMD 10 is allowed to operate in a first operation mode before activation of the image capturing and displaying system 1 including the HMD 10, and to operate in a second operation mode after activation of the image capturing and displaying system 1.

Then, in a case where the HMD 10 is in the first operation mode, as illustrated in FIG. 5, when the lights of the display elements 110a and 110b are turned on, a first timer for turning off the lights of the display elements 110a and 110b after a first period of time (for example, one minute) elapses since the time of turning on the light, is set. In response to time-out of the first timer, the lights of the display elements 110a and 110b are automatically turned off.

Further, in a case where the HMD 10 is in the second operation mode, as illustrated in FIG. 4, when the lights of the display elements 110a and 110b are turned on, the second timer is set after a second period of time (for example, 30 minutes) elapses since the time of turning on the light. The second timer is a timer for outputting a notification message to the user (for example, a message of warming for continuous use for a long period of time).

Then, in a case where the HMD 10 is in the second operation mode after activation of the image capturing and displaying system 1 (FIG. 4), the lights of the display elements 110a and 110b during lighting are turned off, and setting of the second timer is continued in response to shifting of the HMD 10 from the wearing state to the non-wearing state (for example, the period G, the period M). When the HMD 10 is in the second operation mode after activation of the image capturing and displaying system 1 (FIG. 4), when the second timer is to be set (for example, 30 minutes), in a case where the timer is already set, setting of the set timer may be continued without being reset.

In response to time-out of the second timer (for example, 30 minutes), regardless of whether the display elements 110a and 110b are in the lighting state or in the non-lighting state, a notification message to the user is output to the display elements 110a and 110b as image data for display. Here, the notification message is a message to be displayed as the “display content” in FIG. 4, for example, and is a message of warning for continuous use for a long period of time. This allows to call attention to the user. Note that when a user operation is accepted by an input unit (for example, a push switch SW) during displaying of the notification message, the displaying of the notification message may be stopped because the confirmation has already been done.

In addition, in the example of FIG. 4, in the lighting enabled state, an example has been described in which the lights of the display elements 110a and 110b are turned on (for example, at the start time point of the period D) in response to the acceptance of the user operation via the input unit (for example, the push switch SW) that accepts the user operation, but the present invention is not limited to this example. The lights of the display elements 110a and 110b may be automatically turned on at the time of the state shift to the lighting enabled state. Further, the user operation via the input unit (for example, the push switch SW) may be enabled only in a particular state. For example, as described in the present embodiment, a configuration may be applicable in which the user operation is effectively operated only when the HMD 10 is in the wearing state and in the moving state. In other words, a configuration may be applicable in which the timer is not set even when the user operation is performed in a state other than the state described above.

Note that, in the present embodiment, an example has been described in which OSD message control and display lighting control are executed by the system configuration as described above, but the present invention is not limited thereto. For example, the control of the present embodiment can be applied to a case where the stop determination is performed by a captured image instead of the VR device in which the image capturing element is omitted and the IMU, and various parameters may also be appropriately designed depending on the system configuration and the intended use of the device. Moreover, as the input unit, a method using a touch panel or a gesture motion, in addition to the push switch SW may be applicable. For example, the gesture motion of the user may be analyzed based on an image-captured result of the image capturing unit (the image capturing elements 150a and 150b) included in the image capturing and displaying device, and the user operation may be accepted based on the gesture motion. Furthermore, the control configuration may be implemented as hardware or may be implemented by software.

As described above, in the present embodiment, the display element is controlled to be in the lighting enabled state in a case of being in the wearing state where the HMD is mounted on the user and in the moving state where the HMD is moving. This may suppress unwanted lighting of the display when the user is considered not to use the HMD.

Note that the operation modes may be configured to be switchable between the operation modes based on an instruction from another device (for example, the image compositing apparatus 30) or based on a user operation accepted by the input unit (for example, a user operation different from the user operation illustrated in FIG. 4 and FIG. 5).

### Second Embodiment

In a system configuration according to the present embodiment, a basic configuration that is other than the image capturing and displaying device and that has been described using FIG. 1A in the first embodiment is similar to that of the first embodiment, and thus detailed description thereof will be omitted.

System Configuration

FIG. 6 is a system block diagram illustrating an image capturing and displaying system F according to the present embodiment. A difference from FIG. 1A in the first embodiment is that in order to reduce a size of the image capturing and displaying device 10 in FIG. 1A and FIG. 1B, most of the image processing control circuit 100 is separated and is included in an image processing apparatus 40 to be a separate apparatus, as an image processing control circuit 400.

In an image capturing and displaying device 10′ according to the present embodiment, a communication control circuit 190 that communicates with each device and communicates with the outside (the image processing apparatus 40 in the present embodiment, unlike the image compositing apparatus 30 in the first embodiment) is implemented. As a result, the panel lighting control signal 550, output signals of the proximity sensor 140, the IMU 120, and the SW 130, and the like that are illustrated in FIG. 2 pass through the cable 20 in addition to the image signal.

Note that in the present embodiment, the image processing apparatus 40 is configured to have an independent housing according to the configuration as described above, but the present invention is not limited to the configuration. For example, it may be a form that can be installed inside a housing of a PCWS (the image compositing apparatus 30), like a PCI Express extension board.

As described above, according to the present embodiment, undesired lighting of the display can be suppressed.

Note that in each of the embodiments described above, the HMD has been described as an example, but the present invention is not limited to the HMD. For example, it may be a portable display device such as a tablet. For example, when, the proximity sensor is used to detect that the user is holding the display device, it may be determined to be in the wearing state where the display device is mounted on the user. Additionally, determination of the stopping state or the moving state can also be performed in a similar manner to that in a case of the HMD.

According to the present invention, unnecessary lighting of the display can be suppressed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-202620, filed Nov. 7, 2019, which is hereby incorporated by reference herein in its entirety.

What is claimed is:

1. A display device having a display element configured to display an image, the display device comprising:
a wearing state determination unit configured to determine whether or not the display device is in a wearing state where the display device is worn by a user;
a moving state determination unit configured to determine whether the display device is in a stopping state where the display device is stopping or in a moving state where the display device is moving; and
a control unit configured to control the display element to be in a lighting enabled state when the display device is in the wearing state and in the moving state.

2. The display device according to claim 1, wherein
the display device operates in a first operation mode before activation of a system including the display device, and operates in a second operation mode after activation of the system, and
in a case where the display device is in the first operation mode, when a light of the display element is turned on, the control unit sets a first timer for turning off the light of the display element after a first period of time elapses since the time of turning on the light, and
in a case where the display device is in the second operation mode, when the light of the display element is turned on, the control unit sets a second timer for causing to display a notification message to a user after a second period of time longer than the first period of time elapses since the time of turning on the light.

3. The display device according to claim 2, wherein
in a case where the display device is in the second operation mode, the control unit turns off the light of the display element during lighting, and continues setting of the second timer in response to shifting of the display device from the wearing state to a non-wearing state.

4. The display device according to claim 2, wherein
in a case where the display device is in the second operation mode, and in a case where the second timer is already set when the light of the display element is turned on, the control unit continues setting of the set second timer without resetting the second timer.

5. The display device according to claim 2, wherein
the control unit outputs the notification message as image data for display regardless of whether the display element is in a lighting state or in a non-lighting state, in response to time-out of the second timer.

6. The display device according to claim 2, wherein
the control unit turns off the light of the display element in response to time-out of the first timer.

7. The display device according to claim 2, further comprising:
an input unit configured to accept a user operation, wherein
the control unit turns on the light of the display element in response to acceptance of the user operation in the lighting enabled state.

8. The display device according to claim 7, wherein
the input unit is enabled to accept the user operation when the display device is in the wearing state and in the moving state.

9. The display device according to claim 7, wherein
when the user operation is accepted by the input unit during displaying of the notification message, the control unit stops the displaying of the notification message.

10. The display device according to claim 7, wherein
the input unit is a push switch.

11. The display device according to claim 7, wherein
the input unit analyzes a gesture motion based on an image-captured result of an image capturing unit included in the display device, and accepts the user operation based on the gesture motion.

12. The display device according to claim 7, wherein
the control unit is allowed to switch between the first operation mode and the second operation mode based on an instruction from another device or based on a second user operation accepted by the input unit.

13. The display device according to claim 1, wherein
the display device is a head-mounted display device to be mounted on the head of the user.

14. A display system having a display device having a display element configured to display an image, and a control device that is capable of communicating with the display device, the control device comprising:
a wearing state determination unit configured to determine whether or not the display device is in a wearing state where the display device is worn by a user;
a moving state determination unit configured to determine whether the display device is in a stopping state where the display device is stopping or in a moving state where the display device is moving; and
a control unit configured to control the display element to be in alighting enabled state when the display device is in the wearing state and in the moving state.

15. A method of controlling a display device having a display element configured to display an image, the method comprising:
determining whether or not the display device is in a wearing state where the display device is worn by a user;
determining whether the display device is in a stopping state where the display device is stopping or in a moving state where the display device is moving; and
controlling the display element to be in a lighting enabled state when the display device is in the wearing state and in the moving state.

16. A non-transitory computer-readable storage medium storing a computer program for causing a computer to execute a method of controlling a display device having a display element configured to display an image, the method comprising:
determining whether or not the display device is in a wearing state where the display device is worn by a user;
determining whether the display device is in a stopping state where the display device is stopping or in a moving state where the display device is moving; and
controlling the display element to be a lighting enabled state when the display device is in the wearing state and in the moving state.
